(19) United States
(12) Patent Application Publication
(10) Pub. No.: US 2019/0039396 A1
(43) Pub. Date: Feb. 7, 2019

(54) MAGNETIC PAPER PRODUCT CAPABLE OF BEING DIRECTLY PRINTED

(71) Applicant: Guangzhou Newlife Magnet Electricity Co., Ltd., Guangzhou (CN)

(72) Inventors: Xiaoming Wang, Guangzhou (CN); Xuezhao Wang, Guangzhou (CN); Longzhang Wu, Guangzhou (CN); Zhiying Wang, Guangzhou (CN)

(21) Appl. No.: 15/806,630

(22) Filed: Nov. 8, 2017

(30) Foreign Application Priority Data
Aug. 4, 2017 (CN) 201710654934.0

(51) Int. Cl. B41M 5/50

(52) U.S. Cl. CPC B41M 5/502; B41J 2/01

(57) ABSTRACT

A magnetic paper product capable of being printed directly and the preparation method thereof are provided. The product has the unique feature, consisting of a friction-holding covering thin layer, on which sequentially set with a magnetic layer and a printable layer. The friction-holding covering thin layer is a nonwoven fabric called cotton paper (mianzhi) in Chinese. It can achieve the effect of printing magnetic paper after being magnetized, eliminating the trouble that the terminal user has to magnetize the paper after printing, improving the grade of inflexibility of the magnetic paper, reflection of the light and the flatness of the printing surface, solving the problem which has been a plague of the magnetic paper industry and the printing industry for long time.

### TECHNICAL FIELD

The present invention relates to the magnetic material field, and more particularly to magnetic paper used as a consumptive material in printing, faxing, duplicating, and ink-jetting.

### DESCRIPTION OF RELATED ART

A compound material of a combination of magnetic materials and various printable, duplicable or ink-jetted materials has properties of printing, ink-jetting, and duplicating as paper not only, but also has the magnetic property. Products are easily to be displayed and replaced due to the utilization of magnetic adsorption and adhesive-free. Once the magnetic paper products appear, they give advertising supplies, label series, information display system market refreshing, feeling.

But numerous disadvantages of the magnetic paper have to overcome so as to be used conveniently as the ordinary printing paper.

A critical reason that prevents the magnetic paper from being prevalent at present is the magnetic paper needs to be magnetized after being printed, but end clients of printing generally are families, offices of enterprises and schools, printers, etc., some of them can hardly complete it. It is obviously a significant obstacle to utilize the magnetic paper. Reasons for magnetizing the magnetic paper after printing are as follows. 1. The magnetic attractive force between stacked sheets of the magnetic paper makes it difficult to separate individual sheets from the stack for use. 2. The interaction of the magnetic paper and soft magnetic components in the printer leads to failure in feeding the magnetic paper during printing, which causes a jam.

Furthermore, the magnetic paper inherently has following problems. 1. The printing press has a certain temperature itself; the temperature of the magnetic paper is continuously increasing along the feed path; the adhesive in magnetic layers is affected by the increasing temperature, and the degree of inflexibility of the magnetic paper decrease which the movement of the magnetic paper and the leaving from rollers depends on, the magnetic paper will be shifted, which affects the printing effect and leads to a jam. 2. Materials of the printable layer and the magnetic layer of the magnetic paper are different, which makes the surface flat difficult and affects the print effect and causes a jam. 3. Both of too-high or too-low basic weight and the thickness of the magnetic paper will affect the movement and cause the magnetic paper to be stuck on the roller, resulting in poor printing effects and the jam. The basic weight is a parameter of properties of paper, which is the weight per area of the paper tested by a regulated test method, the unit is g/m². 4. The conventional technique to treat the magnetic paper surface is UV-coating or varnishing, resulting in too hardness and smoothness, and the friction on the contact surface of the roller or magnetic roller of the printer is insufficient to resist the sliding movement in the printer and finally being stuck. 5. The dark color on the magnetic side of the magnetic paper after UV-coating or varnishing cannot reflect light, as a result, the printer controlling the feeding of paper by light fails to give a command to feed paper because of the failure in recognition.

Publication date 2003 Jan. 15, publication number: 2530807, entitled an inkjet printable magnetic paper, has been expired owned by Guangzhou Newlife Magnetic Electricity Co., Ltd, provides an inkjet printable magnetic paper, which includes a layer of inkjet. The printing paper is characterized in that an ultra-thin magnetic layer is provided on the bottom surface of the ink jet printing paper and a layer of the varnish, is coated on the bottom surface of the ultra-thin magnetic layer. The magnetic paper not only can be inkjet printing as the general printing paper but also can be adsorbed in the file cabinet, refrigerator, whiteboard and other iron instruments. It brings convenience for the people to post the printed document, notification and so on. But the ultra-thin magnetic layer implied the lack of magnetic force, the product is easy to shed while installation as well as flaws of the degree of inflexibility, flatness, and lack of reflection as described above.

A magnetic paper product capable of being directly printed, publication date is Feb. 10, 2010 and patent number is 200820176937.4, includes a printing layer which can be directly printed. One side of the printing layer is provided with a magnetic coating layer, and the magnetic coating is tightly connected with the surface of the printing layer. The magnetic paper product has small thickness, and the minimal thickness of the magnetic paper product of a single-layer paper structure is only 0.1 mm; moreover, the product has good flexibility, which is basically equal to that of the ordinary paper; and whiling using, more space can be saved, and the application is convenient. The printing layer on one side or two sides of the magnetic paper product can be printed, written and be used for decorating; the application is more convenient; at the same time, the product has light weight, so that larger magnetic force can be obtained, and the magnetic paper product can be attached on the surface of the iron or the magnetic tools more firmly, so as to play the effect of beautification and decoration. The patent has the same shortcomings as the above, the fixation on the wall is unreliable due to the insufficient attraction caused by the thin thickness, as well as the too smoothness, defects of the degree of inflexibility, flatness, failing to reflect the light on the magnetic surface.

The above disadvantages prevent the magnetic products from being used freely by terminal printing clients.

A U.S. patent entitled “Non-Linear Multi-Pole Magnetization of Flexible Magnetic Sheets” with publication number 20160035471 discloses a non-linear multi-pole magnetization pattern is used to magnetize flexible magnetizable sheets. The non-linear pattern is produced by a magnetizing mechanism having a set of angled magnets. Shifting of magnetic sheet positions in a stack is eliminated by randomizing the positions of the multiple magnetic poles in such manner that as the magnetic sheets are stacked, each sheet will have a multi-pole configuration different from the adjacent sheets below and above it on the stack. That solves part of all the problems described above: solves the problem of difficulty in separating individual sheets from the stack due to the magnetic attractive force between such stacked sheets by improving the magnetization method.

A U.S. patent entitled “Portable Magnetizer Sheet Feeder System” with the publication number 20150061800 is a magnetization device targeted on final clients, and the clients are able to magnetize the papers printed by themselves through it. That solves part of the problems: helps final clients to magnetizing the magnetic papers after printing.

A U.S. patent entitled “Material Magnetizer Systems” with publication number U.S. Pat. No. 9,208,934B1 provides a system for magnetization of printed or printable magnetic sheet material. The patent adopts a high-energy magnetization manner and a method of an improved sheet feeder system to achieve the magnetization before printing or the combination of magnetization printing and the magnetization duplicating, as well as solving the problem of insufficient magnetic force of the magnetic paper product which thickness is lower than 0.15 mil or 0.381 mm due to the small amount of magnetic powders. The shortcoming is that the patent needs particular magnetization devices and assistant devices, and the conventional printing device is required to be modified, which is the barrier to widely utilization of the magnetization paper.

It is obvious that the complete elimination of a variety of obstacles of printable magnetic paper to provide a high-quality magnetic paper will bring a great convenience to the printing industry.

But the magnetic paper product is the use of magnetic force to replace the glue. The stronger the magnetic force is, the better the absorbability is. But the printing process is the opposite, it needs more characteristic as paper. The weaker the magnetic force is, the more fluent the printing process is. How to balance the characteristic needs of printing and the absorbability properly is the problem that has been plagued in the printing industry and the magnetic paper industry a long time. This invention will solve the above problem and at the same time overcome the shortage of the degree of inflexibility, the flatness, the refection of light on the magnetic paper.

### SUMMARY

An object and feature of the present invention is to provide a product capable of being directly printed overcoming the above-mentioned problems.

A further object and feature of the present invention is to wisely balance the magnetic properties of the product and the property as paper properly and balance the magnetic absorption and the friction. The magnetic paper capable of being directly printed can be printed by the end customers directly after magnetization, eliminating the trouble of magnetization after printing which solve the major problem that has been plagued in the magnetic paper industry and the printing industry.

A further object and feature of the present invention, is to weaken the magnetic attractive force between stacked sheets of the magnetic paper and the magnetic attractive force between the magnetized product and soft magnetic components in the printer, and strengthen the friction against the direction of the movement of magnetic paper to assist the automatically feeding of paper to be fluent.

A further object and feature of the present invention is to more effectively convert the magnetic attractive force perpendicular to the magnetic paper surface to the friction parallel the direction of the magnetic paper surface and opposite the move direction. So that by the greater friction the magnetic paper can be able to move correctly in the machine, and product installation can be more secure, it also adapts to different thicknesses and weights of the magnetic paper products.

A further object and feature of the present invention is to eliminate one of reasons of the jam—the product slips in the printer. The surface friction is greater than that of the UV-coating or varnishing layer.

An additional object and feature of the present invention is to improve the conventional magnetic paper by providing proper grade of inflexibility, basic weight, and thickness in printing process, so as to, achieve better printing effects.

An additional object and feature of the present invention is the print press controlling the feeding of paper by light sensation can detect the reflective light from this invention product. The magnetic paper capable of being printed directly can better adapt to various printers.

The invention has the advantages of good effect, low cost, ore practicality and applicability.

A magnetic paper product capable of being directly printed with the unique technical feature consists of a friction-holding and covering thin layer, on which a magnetic layer and a printable layer sequentially disposed. The friction-holding and covering thin layer is a nonwoven fabric which is called cotton paper (mianzhi), a special paper, in Chinese.

The nonwoven fabric is made from a plant fiber or a chemical fiber.

The thickness of the nonwoven fabric is 20±10 um, and the basic weight is 14±6 g/m².

The magnetic layer consists of following ingredients: 70% wt-92% wt magnetic powders, 8% wt-30% wt matrix components, and 0-5 wt % additives.

The magnetic powders are at least one of powders of a permanent magnetic material and powders of a soft magnetic material.

The matrix components are at least one of rubbers, thermoplastics and thermoplastic elastomers.

The printable layer is one or a compound structure of two of paper, a printable plastic thin film, a fabric thin film, and a printable coating.

The total thickness of the magnetic paper product is 0.18 mm-1.0 mm.

The basic weight of the product for digital printing and offset printing with an optimum effect is no more than 600 g/m², preferably is 400-550 g/m².

A preparation method of the magnetic paper product capable of being directly printed includes the following steps: pre-treating magnetic powders by a coupling agent to obtain treated magnetic powders, mixing and stirring the treated magnetic powders with adhesives and additives, preparing a magnetic layer by a manner of calendaring, casting or coating, covering the magnetic layer with a printable layer on one side, covering with a friction-holding and covering thin layer on the other side, and magnetizing.

A manner to magnetize the magnetic paper product can be one of a mono-side multi-pole magnetization and a dual-side multi-pole magnetization.

### BRIEF DESCRIPTION OF THE DRAWINGS

FIG. 1 is a cross-sectional schematic diagram of a magnetic paper product capable of being directly printed with force analysis in a vertical direction of the disclosure during mounting and utilizing.

FIG. 2 is a schematic diagram of distribution of magnetic induction lines of magnetic paper with U V-coating in the prior art.

FIG. 3 is a schematic diagram of distribution of magnetic induction lines of magnetic paper capable of being directly printed according to this disclosure.

FIG. 4 is another magnetic paper product capable of being directly printed according to a first contrast embodiment of the disclosure.

FIG. 5 is another magnetic paper product capable of being directly printed according to a second contrast embodiment of the disclosure.

FIG. 6 is an instructional view of a friction test.

FIG. 7 is an instructional view of a suction test.

### DETAILED DESCRIPTION OF PREFERRED EMBODIMENTS

The principle of the disclosure will be further illustrated by specific embodiments with reference to accompanying drawings as follows, but embodiments of the disclosure will not be restricted as such.

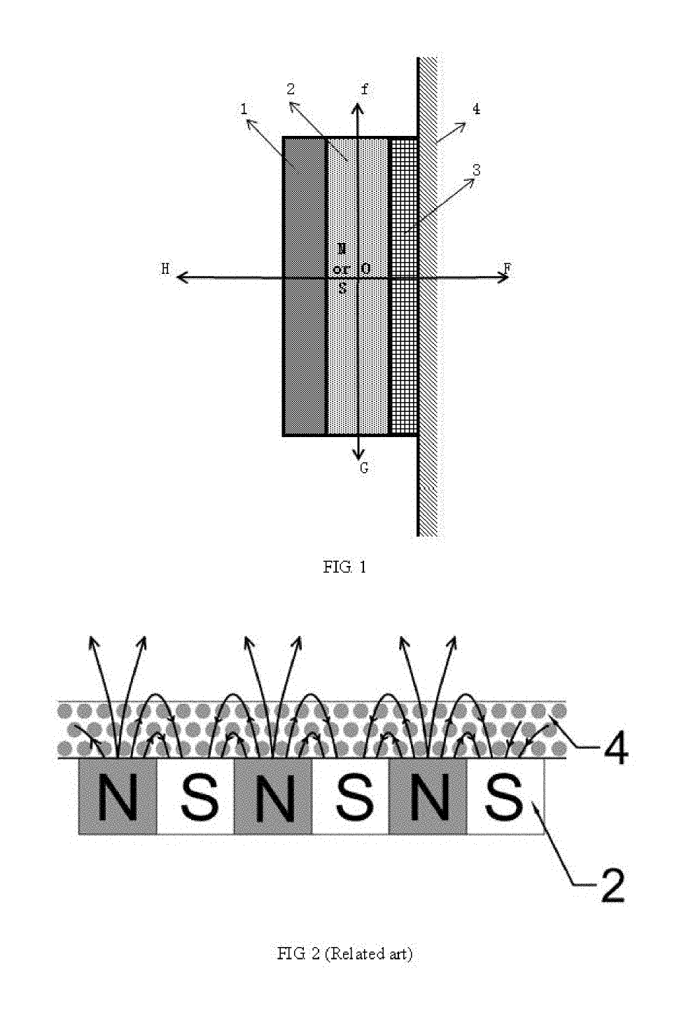

As the force analysis diagram shown in FIG. 1, f is the vertically upward friction; G is vertically downward gravity of the product; F is a horizontal magnetic attractive force perpendicularly pointed to a mounting support surface; H is a horizontal braced force opposite to the direction of F, and 0 represents the abstract origin of forces. It can be clearly seen from the force analysis that it is the vertical upward static frictional force that keeps the product attached to the wall from falling down due to its vertical downward gravity. The expression of the friction is as follows.

f=uF formula 1

Where u is a frictional coefficient; F is an interaction force in a horizontal direction between contact surfaces, which is equal to the horizontal braced force pointed to the magnetic paper and the magnetic attractive force between magnetic materials of the magnetic paper and the mounting support surface. The directions of the two forces (the horizontal braced force and the magnetic attractive force) are opposite and their values are identical. In order to maintain installation of the product firmly, in the case of a certain weight of the product, the maximum static friction must be no less than the product weight, and the maximum static friction depends on the values, of u and F. The greater the value of the F is, the stronger the friction is. But the stronger magnetic force will bring a lot of other factors such as overlapping magnetic paper attracted to each other more tightly that prevents the magnetic sheets automatically rolling through the printer, the interaction of the soft components in the printing, machine and the magnetic paper makes the printer hardly to automatically feed paper. Considering all above factors, this invention sacrifices the magnetic attraction properly, and raises the frictional coefficient to ensure the friction greater than that of the prior art.

As the cross-sectional schematic diagram of the magnetic paper product capable of being directly printed shown in FIG. 1, the magnetic paper product capable of being directly printed includes a printable layer 1, a magnetic layer 2, and a friction-holding and covering thin layer 3. The printable layer 1 can be the art paper. The magnetic layer 2 can be the magnetic layer processed by the multi-pole linear magnetization. The friction-holding and covering thin layer 3 can be the nonwoven fabric layer. The magnetic paper product can be attached to a mounting support surface 4 with magnetic materials. It can be seen from the structure that the difference of the disclosure from the prior art is at least employing the nonwoven fabric instead of UV-coating or varnish to contact with the mounting support surface on the bottom layer of the magnetic paper. The thickness of the nonwoven fabric paper is 20±10 um. According to the suction formula of closed magnetic circuit in the static magnetic air gap:

F=B²A/2μ₀ formula 2

In the above formula 2, F is the suction force. B is the magnetic flux per unit area, μ₀ is the air permeability, and A is a cross-sectional area of the magnetic circuit.

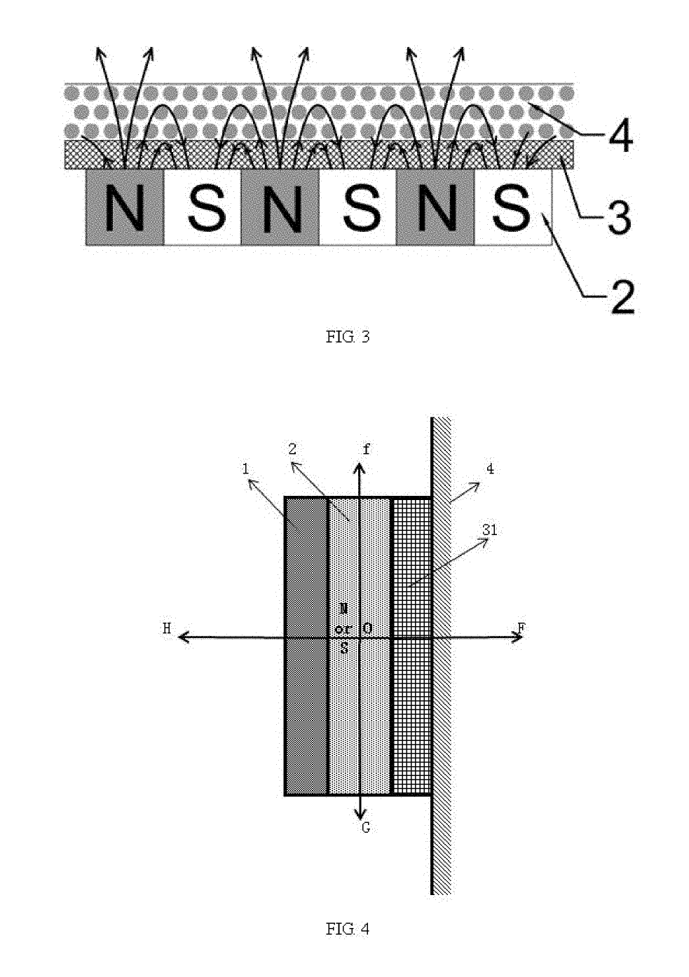

The usage of the nonwoven, fabric friction-holding and covering thin layer slightly pulls away the magnetic paper from the interacted support surface with magnetic materials. The permeability of the nonwoven fabric is similar with that of the air, and B will be reduced correspondingly as explained by comparing FIG. 2 and FIG. 3. F will be reduced therefore.

FIG. 2 is a schematic diagram of distribution of magnetic induction lines of UV-coating in the prior art. In FIG. 2, the magnetic layer 2 contacts with the mount surface immediately for its thickness is 0.1 mm while the thickness of UV-coating 3 is too thin (3 um) to be display.

As shown in FIG. 2, a schematic diagram of distribution of magnetic induction lines in the prior art, and as shown in FIG. 3, a schematic diagram of distribution of magnetic induction lines of magnetic paper capable of being directly printed according to the disclosure the disclosure reduces the quantity of magnetic induction lines distributed in the mounting supported surface 4 and weakens the magnetic force of the magnetic paper on the mounting support surface 4 by the friction-holding and covering thin layer 3 such as a nonwoven fabric, which can reduce the negative effects owing to the magnetic force aforementioned, but the friction coefficient of the friction-holding and covering thin layer 3 such as the nonwoven fabric is greater than that of the prior art, and the friction will be enhanced, which will not affect the mounting and using of the product.

The nonwoven fabric is made from plant fibers or chemical fibers. It is special paper called cotton paper in Chinese. It is used as the base of dual adhesive tape because it is thin, light and durable, which is applied in numerous handicrafts. It is also used as wrapping paper in, industries such as realms of tea, medicine, top graded gifts, cosmetics, garments, and shoes. But the nonwoven fabric used as the intermedium of the force cannot be found in the prior art. It is the first time to introduce the nonwoven fabric as force, media to the magnetic paper capable of being directly printed; the attractive force perpendicular to the surface of the magnetic paper is converted to the friction parallel the magnetic paper surface more efficiently, simultaneously increasing the flatness and the degree of inflexibility of the magnetic paper. The coverage of the nonwoven fabric on the magnetic layer allows light reflected to the printer for feeding paper by optical control.

A magnetic paper product capable of being directly printed with the unique technical feature consists of a friction-holding and covering thin layer 3, on which sequentially set with a magnetic layer 2 and a printable layer 1. The friction-holding and covering thin layer 3 is a nonwoven fabric called cotton paper (mianzhi), a special paper, in Chinese.

Preferably, the nonwoven fabric is made from plant fibers or chemical fibers.

Further preferably, the thickness of the friction-holding and covering thin layer is 20±10 um, and a basic weight is 14±6 g/m².

Preferably, the magnetic layer consists of following ingredients: 70% wt-92% wt magnetic powders, 8% wt-30% wt matrix components, and 0-5% wt additives.

Further preferably, the magnetic powders are at least one of powders of a permanent magnetic material and powders of a soft magnetic material.

Further preferably, the permanent magnetic material can be selected from strontium ferrite magnetic powders and barium ferrite magnetic powders. The soft magnetic material powders primarily are chosen from powders of iron, cobalt, nickel, and compounds with iron, cobalt, nickel.

Further preferably, the matrix components are rubbers, thermoplastics or thermoplastic elastomers.

Further preferably, the matrix components are at least one of chlorinated polyethylene (CPE), nitrile butadiene rubber (NBR), hydrogenated nitrile-butadiene rubber (HNBR), polyvinyl chloride (PVC), polyethylene (PE), poly propylene (PP), polyolefin elastomer (POE), ethylene-vinyl acetate copolymer (EVA), acetoacetic acid ethyl ester (EAA), ethylene ethylacrylate copolymer (EEA), thermoplastic elastomer (TPE), thermoplastic polyurethanes (Tpu), hydrogenated styrene-butadiene thermoplastic elastomer (SEBS), styrene-butadiene thermoplastic elastomer (SBS), versify, vistamass, isoprene rubber (IR), isobutylene isoprene rubber (IIR), chloroprene rubber (CR), ethylene propylene diene monomer (EPDM) rubber, natural rubber (NR), EVA latexes, VAE emulsions, styrene-acrylic latex, silicone acrylic emulsions, pure acrylic emulsions, vinyl acetate-acrylate emulsions, and polyurethane emulsions.

Further preferably, the additives are at least one of antioxidants, stabilizers, lubricants, coupling agents, ultraviolet absorbers, dispersants, antifoaming agents and thickeners.

Further preferably, the printing layer is paper, printable and writable plastic thin films, textile thin films, printable coatings.

Far preferably, the paper includes at least one, two or more than two of the following listed compound structures: ordinary writing paper, art paper, inkjet printing paper, highlighted or matte photograph paper, and synthetic paper.

Preferably, the thickness of the magnetic layer is 0.1-0.25 mm, and the basic weight is 300±750 g/m².

Preferably, the total thickness of the magnetic paper capable of being directly printed is 0.18 mm-1.0 mm.

Preferably, the basic weight of the magnetic product capable of being directly printed for digital printing and offset printing with an optimum effect is no more than 600 g/m², preferably is 400-550 g/m². The optimal thickness of the magnetic paper is 0.24-0.455 m.

A preparation method of the magnetic paper product capable of being directly printed includes following steps: pre-treating magnetic ponders by a coupling agent to obtain treated magnetic powders, mixing and stirring the treated magnetic powders with matrix components and additives, preparing a magnetic layer by a manner of calendering, casting or coating, covering the magnetic layer with the printable layer on one side and covering the magnetic layer with the friction-holding and covering thin layer on the other side, magnetizing, and cutting the product for delivery.

Preferably, a method to magnetize the product can be one of mono-side multi-pole magnetization and dual-side multi-pole magnetization.

Details are as follows.

Step 1: mixing, raw materials of the magnetic layer are mixed with the ratio of 88% wt magnetic powders, 10% wt matrix component which can be thermoplastic resin, and 2% wt auxiliary agent. The magnetic powders are strontium ferrite magnetic powders; the matrix component is the thermoplastic; the additives/auxiliary agents are a calcium zinc stabilizer, a coupling agent and a lubricant stearic acid (mass ratio 1:1:1).

Step 2: calendering, the mixture produced in step 1 will be crushed into fine powders, then the fine powders are processed and molded by the calender.

The conventional magnetic layer whose thickness is 0.1 mm and produced by the coating method is changed to be produced by the calendering method to increase the content of magnetic powders, so as to improve the problem of insufficient magnetic forces due to the thin magnetic layer.

Step 3, covering, both sides of calendered magnetic layer are covered respectively with the printable layer and the nonwoven fabric.

Step 4, magnetizing, magnetize multi-poled the product made in step 3 on one side or both sides.

Step 5, cutting, the product is cut into pieces whose size is as the requirement of clients along directions of the magnetic path or the vertical calendaring.

Or another embodiment of the disclosure is provided as follows.

Step 1: mixing, raw materials of the magnetic layer are mixed with the ratio of 88% wt magnetic powder, 10% wt latex and 2% wt additives. The magnetic powders are strontium ferrite magnetic powders, and the matrix component is latex, and the auxiliary agent is a defoaming agent, a thickening agent and a leveling agent (mass ratio 1:1:1).

Step 2, coating, the mixed slurry prepared in step 1 is coated on the art paper by the coating machine and dried.

Step 3, covering, the other side of the coated magnetic layer is covered by the nonwoven fabric.

Step 4, magnetizing, magnetize multi-poled the product made in step 3 on one side or both sides.

Step 5, cutting, the product is cut into pieces whose size is as requested by clients along directions of the magnetic path or the vertical calendaring.

Or another embodiment of the disclosure is provided as follows.

Step 1: mixing processing, raw materials of the magnetic layer are mixed with the ratio of 80% wt magnetic powders, 18% wt matrix component, and 2% wt additive. The magnetic powders are strontium ferrite magnetic powders. The matrix component is thermoplastic elastomer; said additive is an antioxidant 1010, a lubricant stearic acid, and aluminate as a coupling agent (mass ratio 1:1:1).

Step 2: casting, the mixed slurry is hot pressed on the art paper by extrusion casting.

Step 3: covering, a nonwoven fabric will be covered on the other side of the magnetic layer by casting in step 2.

Step 4, magnetization, magnetize the product by multi-poled made in step 3 on one side or two sides.

Step 5, cutting, the product is cut into pieces whose size is as requested by clients along directions of the magnetic path or the vertical calendering.

### Embodiment 1

Referring to FIG. 1, a magnetic paper product capable of being directly printed consists of the friction-holding and covering thin layer 3 such as a nonwoven fabric called cotton paper (mianzhi) in Chinese having a thickness of 0.02 mm, on which sequentially set with a magnetic layer 2 having a thickness of 0.1 mm and a printable layer 1 such as an art paper thin film 1 with printable coating having basic weight 128 g/m².

Step 1: mixing, raw materials of the magnetic layer are mixed with the ratio of 88% wt magnetic powders, 10% wt matrix component which can be thermoplastic resin, and 2% wt auxiliary agent. The magnetic powders are strontium ferrite magnetic powders; the matrix component is chlorinated polyethylene CPE; the additives are a calcium zinc stabilizer, a coupling agent and a lubricant stearic acid (mass ratio 1:1:1)

Step 2: calendering, the mixture will be crushed into fine powder, then the fine powders are processed and molded by the calender.

Step 3, covering, both sides of the calendered magnetic layer are respectively covered by art paper with basic weight 128 g/m² and the nonwoven fabric called cotton paper (mianzhi) in Chinese.

Step 4, magnetizing, the product made in step 3 is magnetized on nonwoven fabric called cotton paper (mianzhi) in Chinese by multi-pole parallel lines with line spacing 1.0 mm.

Step 5, cutting, the product is cut into pieces whose size is 460*320 mm along directions of the magnetic paths or the vertical calendering.

Related parameters of a piece of the product: the weight is 73.6 g, the tested friction is 2.208 kg, and the attractive force is 3.68 kg.

100 pieces of magnetic paper are experimented by HP INDIGO 7800 printing press, resulting in steady feeding paper, satisfactory printing effect, and firm installation.

### Embodiment 2

Referring to FIG. 1, a magnetic paper product capable of being directly printed consists of a friction-holding and covering thin layer 3 such as the nonwoven fabric called cotton paper (mianzhi) in Chinese having a thickness of 0.02 mm, on which sequentially set with a magnetic layer 2 having a thickness of 0.15 mm, and a printable layer 1 such as an art paper thin film with printable coating having basic weight of 128 g/m².

Step 1: mixing, raw materials of the magnetic layer are mixed with the ratio of 88% wt magnetic powders, 10% wt latex, and 2% wt additives. The magnetic powders are strontium ferrite magnetic powders; the matrix component is EVA latex; the auxiliary agent is a defoaming agent, a thickening agent and a leveling agent (mass ratio 1:1:1).

Step 2, coating, the mixed slurry is coated on the art paper by the coating machine and dried.

Step 3, covering, the other side of the magnetic layer is covered by the nonwoven fabric called cotton paper (mianzhi) in Chinese.

Step 4, magnetizing, the product made in step 3 is magnetized on the nonwoven fabric called cotton paper (mianzhi) in Chinese by multi-pole parallel lines with line spacing 1.5 mm.

Step 5, cutting, the product is cut into pieces with the size of 460*320 mm along directions of the magnetic paths parallel one side of the pieces whose length is 460 mm.

Related parameters of a piece of the product: the weight is 88.3 g, the tested friction is 4.416 kg, and the attractive force is 7.36 kg.

100 pieces of magnetic paper are experimented by HP INDIGO 7800 printing press, and feeding paper is steady. The printing effect is satisfactory, and the installation is firm.

### Embodiment 3

Referring to FIG. 1, a magnetic paper product capable of being directly printed consists of a friction-holding and covering thin layer 3 such as the nonwoven fabric called cotton paper (mianzhi) in Chinese having a thickness of 0.02 mm, on, which sequentially set with a magnetic layer 2 having a thickness of 0.25 mm, and a printable layer 1 such as an art paper thin film with printable coating having basic weight of 128 g/m².

Step 1: mixing processing, raw materials of the magnetic layer are mixed with the ratio of 80% wt magnetic powders, 18% wt thermoplastic elastomers, and 2% wt additives. The matrix component is EVA and ethylene-propylene copolymer elastomer (mass ratio 1:1); said additive is an antioxidant 1010, a lubricant st;aric acid, and a coupling agent aluminate (mass ratio 1:1:1).

Step 2: casting, the mixture is directly hot pressed to art paper through the extrusion casting method, and the pressed mixture is dried.

Step 3: covering, nonwoven fabric called cotton paper (mianzhi) in Chinese will be covered on the other side of the magnetic layer by casting in step 2.

Step 4, magnetizing, the product made in step 3 is magnetized by multi-pole parallel lines with line spacing 1.5 mm on the nonwoven fabric called cotton, paper (mianzhi) in Chinese.

Step 5, cutting, the product is cut into pieces whose size is 460*320 mm along directions of the magnetic paths parallel one side of the pieces whose length is 460 mm.

Related parameters of a piece of the product: the weight is 117.8 g, the tested friction is 5.299 kg, and the attractive force is 8.832 kg.

100 pieces of magnetic paper are experimented by HP INDIGO 7800 printing press, resulting in steady feeding paper, satisfactory printing effect, and firm installation.

### Contrast Embodiment 1

Referring to FIG. 4, another magnetic paper product capable of being directly printed sequentially consists of an ordinary wood-free paper layer 31 having basic weight of 70 g/m², the magnetic layer 2 having a thickness of 0.1 mm, and the art paper thin film 1 with printable coating having basic weight of 128 g/m².

Step 1: mixing, raw materials of the magnetic layer are mixed with the ratio of 88% wt magnetic powders, 10% wt matrix component which can be thermoplastic resin, 2% wt auxiliary agent. The magnetic powders are strontium ferrite magnetic powders; the matrix component is chlorinated polyethylene CPE; the additives are a calcium zinc stabilizer, a coupling agent and a lubricant stearic acid (mass ratio 1:1:1).

Step 2: calendering, the mixture is crushed into fine powders, then the fine powders are processed and molded through the calender.

Step 3, covering, both sides of calendered layer are covered respectively with the ordinary wood-free paper having basic weight 70 g/m² and an art paper thin film with printable coating having basic weight of 128 g/m².

Step 4, magnetizing, the product made in step 3 is magnetized on wood-free print paper surface by multi-pole parallel lines with line spacing 1.0 mm.

Step 5, cutting, the product is cut into pieces with the size of 460*320 mm along directions of the magnetic paths.

Related parameters of a piece of the product: the weight is 81 g, the tested friction is 207 g, the attractive force is 368 g, and the total thickness is 0.3 mm.

100 pieces of magnetic paper are experimented by HP INDIGO 7800 printing press, resulting in steady feeding paper. The printing effect is general and some of the edges of the, magnetic paper are curved and easy to fall off from the installation surface.

### Contrast Embodiment 2

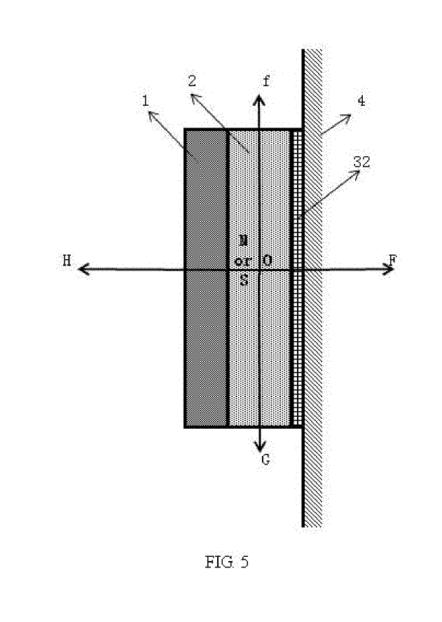

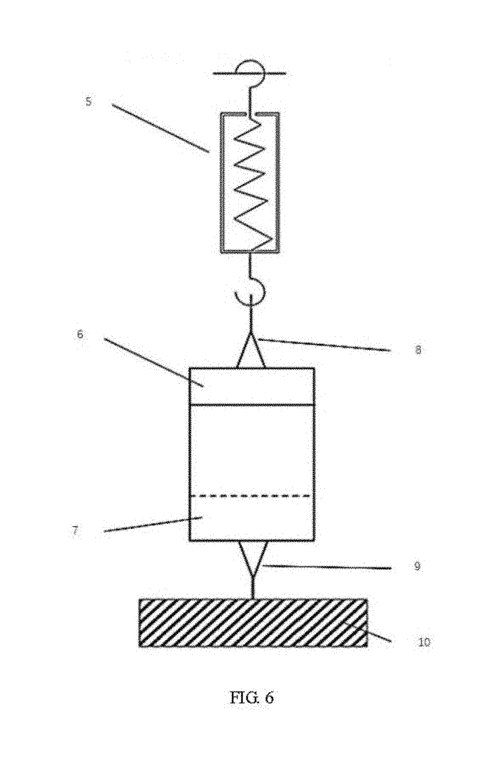

Referring to FIG. 5, another magnetic paper product capable of being directly printed sequentially consists of a UV-coating 32 having thickness of 3 um, the magnetic layer 2 having a thickness of 0.1 mm, and the art paper thin film 1 with printable coating having basic weight of 128 g/m².

Step 1: mixing, raw materials of the magnetic layer are mixed with the ratio of 88% wt magnetic powders, 10% wt matrix component which can be thermoplastic resin, and 2% wt auxiliary agent. The magnetic powders strontium ferrite magnetic powders; the matrix component is chlorinated polyethylene CPE; the additives are a calcium zinc stabilizer, a coupling agent and a lubricant stearic acid (mass ratio 1:1:1).

Step 2: calendering, the mixture is crushed into fine powders, then the fine powders are processed and molded through the calender.

Step 3, covering, both sides of calendered layer are covered respectively with the art paper whose basic weight is 128 g/m² and the UV-coating.

Step 4, magnetizing, the product made in step 3 is magnetized on the UV-coating surface by multi-pole parallel lines with line spacing 1.0 mm.

Step 5, cutting, the product is cut into pieces with the size of 460*320 mm along directions of the magnetic paths.

Related parameters of a piece of the product: the weight is 71.8 g, the tested friction is 2060 g, and the attractive force is 5152 g.

100 pieces of magnetic paper are experimented by HP INDIGO 7800 printing press, and the paper cannot run through the printer, but the installation is fine.

Related parameters of 3 embodiments and 2 contrast embodiments are listed as below.

| | | | | Contrast | Contrast |
|---|---|---|---|---|---|
| | Embodiment 1 | Embodiment 2 | Embodiment 3 | Embodiment 1 | Embodiment 2 |
| Printing layer 1 | Art paper (128) | Art paper (128) | Art paper (128) | Art paper (128) | Art paper (128) |
| (basic weight) (g/m²) | | | | | |
| Magnetic layer 2 | Magnetic layer | Magnetic layer | Magnetic layer | Magnetic layer | Magnetic layer |
| (Thickness mm) | (0.1 mm) | (0.15 mm) | (0.25 mm) | (0.1 mm) | (0.1 mm) |
| Bottom layer 3 | Nonwoven | Nonwoven | Nonwoven | Wood-free | UV-coating |
| | fabric called | fabric called | fabric called | printed paper | |
| | cotton paper | cotton paper | cotton paper | 70 g g/m2 | |
| Formation of | Calendering | Coating | Casting | Calendering | Calendering |
| magnetic layer | | | | | |
| Total thickness | 0.24 | 0.29 | 0.39 | 0.3 | 0.21 |
| (mm) | | | | | |
| Magnetizing | Magnetize by one-sided multi-pole magnetized parallel lines on the surface of layer 3 | | | | |
| | with line spacing | with line spacing | with line spacing | with line spacing | with line spacing |
| | 1.0 mm | 1.0 mm | 1.5 mm | 1.0 mm | 1.0 mm |
| Size of a piece (mm) | 460*320 | 460*320 | 460*320 | 460*320 | 460*320 |

Tested data of 3 embodiments and 2 contrast embodiments

| | | | | Contrast | Contrast |
|---|---|---|---|---|---|
| | Embodi- | Embodi- | Embodi- | Embodi- | Embodi- |
| | ment 1 | ment 2 | ment 3 | ment 1 | ment 2 |
| Attractive | 3680 | 7360 | 8832 | 368 | 5152 |
| force of a | | | | | |
| piece (g) | | | | | |
| Attractive | 2~3 | 4~6 | 6~8 | 0~1 | 3~4 |
| force of a | | | | | |
| unit area | | | | | |
| (g/cm²) | | | | | |
| Weight of a | 73.6 | 88.3 | 117.8 | 81 | 71.8 |
| piece (g) | | | | | |
| Friction (g) | 2208 | 4416 | 5299 | 207 | 2060 |
| Friction | 30 | 50 | 45 | 2.6 | 29 |
| (g)/Weight | | | | | |
| of a piece (g) | | | | | |
| Friction | 0.60 | 0.60 | 0.60 | 0.56 | 0.40 |
| coefficient | | | | | |

The result of 100 pieces experimented by HP INDIGO 7800 printing press

| | | | | Contrast | Contrast |
|---|---|---|---|---|---|
| | Embodi- | Embodi- | Embodi- | Embodi- | Embodi- |
| | ment 1 | ment 2 | ment 3 | ment 1 | ment 2 |
| Feeding | Feeding | Feeding | Feeding | Feeding | Failed in |
| in the | fluently | fluently | fluently | fluently | feeding, |
| print press | | | | | sliding |
| Print quality | Very | Satisfied | Satisfied | general | NA |
| | satisfied | **** | **** | *** | |
| | ***** | | | | |
| Installation | Firm | Firm | Firm | Curved | Firm |
| | | | | edges, | |
| | | | | unsecure | |

Remark: Grades of the printing effect sequentially are very satisfied *****, satisfied ****, general ***, poor **, very poor *.

What can be seen from the table:

1. The friction coefficient of the cotton paper is 0.6, the friction coefficient of the UV-coating is 0.4, and the friction coefficient of the wood-free printed paper is 0.56.

2. In the three specific embodiments with the friction-holding and covering thin layer, or the nonwoven fabric called cotton paper (mianzhi) in Chinese, the friction and magnetic attraction are not weak, and the magnetic paper can be fed in the machine fluently and installed firmly and the printing effect is satisfactory.

3. In the comparative embodiments with the wood-free paper, the friction and magnetic attraction are weak, and the paper can be fed in the machine but can't be installed firmly, as well as easy to, fall off, and the printing effect is general.

4. When the bottom of the magnetic surface connected with, the mounting surface is the uv-coating, the suction and friction are not weak, but compared to embodiment 1, the suction is greater and the friction is weaker, therefore failed to feed paper in the printing press, and the surface is not flat. The only good result is the installation can be firm.

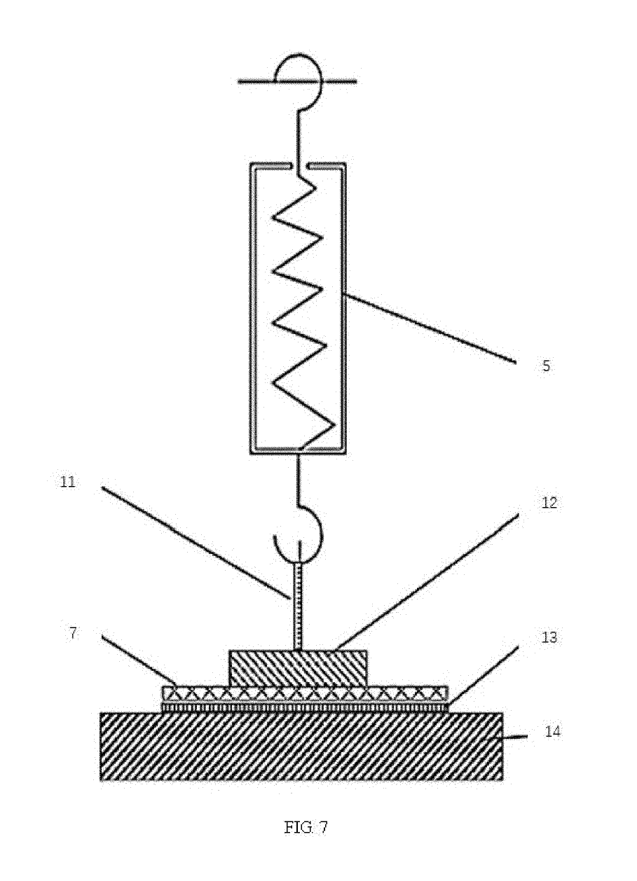

FIG. 6 shows the spring dynamometer 5, a painted iron plate 6 whose thickness is 0.2 mm and whose area is 10 cm*10 cm, magnetic printing paper 7 needed to be tested whose magnetized side is contacted with the painted iron plate 6, a rope 8 ties the painted iron plate 6 to the hook of the spring dynamometer 5, a rope 9 ties the magnetic printing paper 7 to a base 10, and the base 10.

The friction test is illustrated as below. The magnetized surface of the magnetic paper 7 needed to be tested is absorbed on the painted iron plate 6; the magnetic paper 7 needed to be tested is tied to the base 10 by the rope 9 at the bottom surface of which without absorption; the painted iron plate 6 is tied to the hook of the spring dynamometer 5 by the rope 8 on the top surface of which without absorption. The maximal pull f′ is tested by pulling the spring dynamometer 5 upward.

The maximal friction f=the tested maximal pull f′−weights of the painted iron plate 6, the magnetic paper product and the rope hanging the painted iron plate 6.

FIG. 7 is the instruction of the suction test.

FIG. 7 shows the spring dynamometer 5, a straining rod 11, and a round iron plate 12 whose thickness is 5 mm and whose area is 10 cm². The magnetic printing paper 7 has the larger area than the round iron plate 12 does, and a double sided tape 13 is adopted for sticking the magnetic printing paper 7 and a flat aluminum fixed base 14. The straining rod 11 can be a handle of the round iron plate 12.

The illustration of the attractive force test is as follows. The magnetic printing paper 7 is pasted on the flat aluminum fixed base 14 with the magnetic surface facing upwards by the double sided tape 13. The maximal pull F′ is achieved by pulling up the round iron plate 12 via the straining rod 11 connected therewith away from the magnetic printing paper 7 by the spring dynamometer 5.

The unit attractive force of the magnetic layer F=[the maximal pull F′ of the spring dynamometer−weights of the round iron disk with the straining rod and the product]/10.

To a person skilled in the art, improvements and decoration on the surface such as printing, coating, overlapping, embossing, etc. within the principle of the disclosure and modification, substitution, combination and simplification according to the spirit of the disclosure are equivalent counterparts, which should be included in the protective scope of the disclosure.

What is claimed is:

1. A magnetic paper product capable of being directly printed, consisting of a friction-holding and covering thin layer, a magnetic layer and a printable layer sequentially disposed on a side of the friction-holding and covering thin layer, wherein said friction-holding and covering thin layer is a nonwoven fabric.

2. The magnetic paper product capable of being directly printed according to claim 1, wherein said nonwoven fabric is made from a plant fiber or a chemical fiber.

3. The magnetic paper product capable of being directly printed according to claim 1, wherein a thickness of said nonwoven fabric is 20±10 um, a basic weight of said nonwoven fabric is 14±6 g/m².

4. The magnetic paper product capable of being directly printed according to claim 1, wherein said magnetic layer consists of following ingredients: 70% wt-92% wt magnetic powders, 8% wt-30% wt matrix components, and 0-5% wt additives.

5. The magnetic paper product capable of being directly printed according to claim 4, wherein said magnetic powders are at least one of powders of a permanent magnetic material and powders of a soft magnetic material.

6. The magnetic paper product capable of being directly printed according to claim 4, wherein said matrix components are at least one of rubbers, thermoplastics and thermoplastic elastomers.

7. The magnetic paper product capable of being directly printed according to claim 1, wherein said printable layer is one or a compound structure of two of paper, a printable plastic thin film, a fabric thin film, and a printable coating.

8. The magnetic paper product capable of being directly printed according to claim 1, wherein a total thickness of said magnetic paper product is 0.18 mm-1.0 mm.

9. The magnetic paper product capable of being directly printed according to claim 1, wherein a basic weight of said magnetic paper product for digital printing and offset printing with an optimum effect is no more than 600 g/m².

10. The magnetic paper product capable of being directly printed according to claim 9, wherein the basic weight of said magnetic paper product for digital printing and offset printing with the optimum effect is 400-550 g/m².

11. A preparation method of the magnetic paper product capable of being directly printed according to claim 1, wherein said preparation method comprises following steps: pre-treating magnetic powders by a coupling agent to obtain treated magnetic powders, mixing and stirring the treated magnetic powders with matrix components and additives to prepare a magnetic layer by a manner of calendering, casting or coating, covering the magnetic layer with a printable layer on one side and a friction-holding and covering thin layer on the other side, then magnetizing.

12. The preparation method according to claim 11, wherein said manner to magnetize said magnetic paper product is one of a mono-side multi-pole magnetization and a dual-side multi-pole magnetization.
